(19) United States
(12) Patent Application Publication
(10) Pub. No.: US 2011/0198284 A1
(43) Pub. Date: Aug. 18, 2011

(54) METHOD FOR THE TREATMENT OF WASTEWATER CONTAINING AMMONIA

(75) Inventor: Geert Nyhuis, Gommiswald (CH)

(73) Assignee: CYKLAR-STULZ ABWASSERTECHNIK GMBH, Gommiswald (CH)

(21) Appl. No.: 13/062,543

(22) PCT Filed: Aug. 7, 2009
(86) PCT No.: PCT/IB09/06727

§ 371 Date: Mar. 7, 2011

(30) Foreign Application Priority Data
Sep. 12, 2008 (EP) 08 016 104.5
Jan. 22, 2009 (EP) 09000829.3

(51) Int. Cl. C02F 3/30

(52) U.S. Cl. 210/626

(57) ABSTRACT

A method for treating wastewater containing ammonium in a de-ammonifying activated-sludge system includes converting a portion of the ammonium into nitrite using aerobically oxidizing bacteria and converting another portion of the ammonium and the nitrite into elementary nitrogen using anaerobically oxidizing bacteria so as to generate a surplus sludge. The surplus sludge is removed from the waste water and separated into a heavy phase including primarily anaerobic ammonium-oxidizing bacteria and a light phase. The heavy phase is collected and/or returned to the system.

### CROSS REFERENCE TO RELATED APPLICATIONS

This application is a U.S. National Phase application under 35 U.S.C. §371 of International Application No. PCT/IB2009/006727, filed on Aug. 7, 2009, and claims benefit to European Patent Application No. EP 08 016 104.5, filed on Sep. 12, 2008 and European Patent Application No. EP 09 000 829.3, filed on Jan. 22, 2009. The International Application was published in German on Mar. 18, 2010 as WO 2010/029399 A1 under PCT Article 21 (2).

### FIELD

The invention relates to a method for treating wastewater containing ammonium in a de-ammonifying activated-sludge system, in which ammonium is first converted into nitrite by means of aerobically oxidizing bacteria (AOB), and subsequently ammonium and nitrite are converted into elementary nitrogen by means of anaerobically oxidizing bacteria (AMOX or ANAMMOX), especially Planctomycetes, whereby the surplus sludge generated in this process is discharged from the tank.

### BACKGROUND

International patent application WO 97/33839 A1 describes a method for purifying wastewater in which the wastewater is microbially converted by a biological treatment with activated sludge, then the activated sludge is separated from the microbially converted wastewater and subjected to a sludge treatment, after which sludge water is extracted from the treated activated sludge, and the return water obtained from the sludge water is returned to the biological treatment process.

European patent application EP 0 634 370 A1 describes a method for purifying nitrogenous wastewater using sludges as the substrate.

European patent application EP 0 393 674 A1 describes a method for biological wastewater purification, especially for the nitrification and/or de-nitrification of nitrogenous wastewater, while European patent application EP 0 949 206 A1 likewise describes a method for the biological de-nitrification of wastewater. Another method for treating wastewater is described in U.S. Pat. No. 2,337,507.

Current conventional wastewater treatment systems employ almost exclusively biological nitrification/de-nitrification for purposes of nitrogen elimination. The term “nitrogen elimination” refers to the conversion of bioavailable nitrogen compounds such as ammonium (NH₄), nitrite (NO₂) and nitrate (NO₃) into elementary nitrogen (N₂), which then outgases as a harmless end product into the ambient air. During the nitrification process, ammonium is oxidized by oxygen via the intermediate product nitrite so as to form nitrate. During the subsequent de-nitrification, the nitrate is reduced to nitrite in a first reduction step and then into nitrogen in a second reduction step.

Biological nitrification/de-nitrification has the drawback that it entails a high oxygen demand and thus a high energy consumption. Moreover, the de-nitrification consumes organic carbon, which has a detrimental effect on the subsequent purification process and properties of the sludge.

In comparison to nitrification/de-nitrification, de-ammonification requires only half as much oxygen or the energy consumption for the nitrogen elimination is cut in half. The de-ammonification is an autotrophic process that does not require any organic carbon. As a result, the remaining purification process is more stable.

De-ammonification is an efficient method for biological nitrogen elimination, for example, even in the case of wastewater containing high concentrations of ammonium. Two bacteria groups are involved in biological de-ammonification with suspended biomass, namely, on the one hand, the aerobic ammonium-oxidizing bacteria (AOB), which convert ammonium into nitrite and, on the other hand, the anaerobic, ammonium-oxidizing and elementary nitrogen-producing (AMOX) bacteria, especially Planctomycetes, which execute this step by means of the previously produced nitrite.

In terms of the substance conversion, aerobic ammonium-oxidizing bacteria (AOB) produce 10 times more new bacteria mass than anaerobic ammonium-oxidizing bacteria (AMOX). Therefore, the retention time of the sludge in a single-sludge system has to be at least long enough for the slow-growth anaerobic ammonium-oxidizing bacteria (AMOX) to accumulate.

A method for single-stage biological de-ammonification of the above-mentioned type is described in international patent application WO 2007/033393 A1. European patent applications EP 0 391 023 B1, EP 0 327 184 B1 and international patent application WO 00/05176 A1 also describe single-stage or two-stage de-ammonification.

A particular drawback here is that the generation times of the anaerobic ammonium-oxidizing bacteria (AMOX) are considerably longer, namely, ten times longer than those of the aerobic ammonium-oxidizing bacteria (AOB). As a result, a stable system can only form if the retention time of the sludge or of the bacteria in the tank is sufficiently long. This, in turn, calls for large reaction volumes and correspondingly dimensioned tanks.

Moreover, a sufficiently high wastewater temperature (>25° C.) is the prerequisite for the existence or growth of anaerobic ammonium-oxidizing bacteria (AMOX). Heating the wastewater, however, requires a great deal of energy, which is why the described methods are not economically applicable or feasible for wastewater that is at low temperatures.

Furthermore, the presence of such bacteria groups (NOB) which convert the formed nitrite into nitrate under aerobic conditions has proven to be disadvantageous. This group of bacteria displays generation times that are ten times shorter than those of anaerobic ammonium-oxidizing bacteria (AMOX). In order to compensate for these different generation times, it has already been proposed to operate the aerated phase of the single-sludge system at a very low oxygen level (<0.4 mg O₂/l). In this manner, little or no oxygen is available to the nitrate-forming bacteria (NOB) to convert the nitrite which, in turn, is very advantageous for the anaerobic ammonium-oxidizing bacteria (AMOX). The reduced oxygen supply during the aerated phase, however, has the drawback that the aerobic conversion of the ammonium into nitrite is likewise oxygen-limited and consequently takes place very slowly.

### SUMMARY

An aspect of the invention is to provide an improved and economically feasible method for treating wastewater containing ammonium.

In an embodiment, the present invention provides a method for treating wastewater containing ammonium in a de-ammonifying activated-sludge system includes converting a portion of the ammonium into nitrite using aerobically oxidizing bacteria and converting another portion of the ammonium and the nitrite into elementary nitrogen using anaerobically oxidizing bacteria so as to generate a surplus sludge. The surplus sludge is removed from the waste water and separated into a heavy phase including primarily anaerobic ammonium-oxidizing bacteria and a light phase. The heavy phase is collected and/or returned to the system.

### BRIEF DESCRIPTION OF THE DRAWINGS

Exemplary embodiments of the present invention are described in more detail below with reference to the drawings, in which:

FIG. 1 shows a schematic diagram of a single-tank system for treating wastewater containing ammonium; and

FIG. 2 shows a schematic diagram of an activated-sludge system for treating wastewater containing ammonium.

### DETAILED DESCRIPTION

Thus, embodiments of the invention provide a method in which the discharged surplus sludge is separated into a heavy phase, which contains primarily the anaerobic ammonium-oxidizing bacteria (AMOX), and into a light phase, whereby the heavy phase is returned to the system and/or collected and fed to another system, while the light phase is disposed of. Since the Planctomycetes are not present in the floc and have a higher density, the surplus sludge can be separated into a heavy phase and a light phase. The Planctomycetes (AMOX) grow very densely, with a density of about 10¹⁰ bacteria/ml. Owing to the disposal of the light phase and the return of the heavy phase to the tank, the slow-growing group of anaerobic ammonium-oxidizing bacteria (AMOX) can accumulate. The proportion of anaerobic ammonium-oxidizing bacteria (AMOX), which makes up less than 10% of the biomass in a single-sludge system for pure nitrogen elimination, for instance, for treating wastewater with high nitrogen concentrations with non-specific surplus sludge removal, can be raised to more than 30% by means of methods according to the invention. As a result, the reaction volume of the tank can be reduced accordingly and the process stability of the system can be increased. The wastewater constituents that are heavier than the Planctomycetes have to be segregated before reaching the activated-sludge system since otherwise, they would likewise accumulate in the system. Such a segregation is carried out in a primary clarification tank or in a settling tank which can have small dimensions due to the high settling rate of the Planctomycetes. The activated-sludge system can especially be configured as a single-stage, one-tank system or as a multi-tank system.

As an advantage of embodiments of the invention, the temperature of the wastewater, which influences the presence or growth of the anaerobic ammonium-oxidizing bacteria (AMOX), is not a decisive factor, so that the de-ammonification can still be employed effectively and with process reliability, even for wastewater that is at a temperature of about 10° C.

The temperature influences all of the bacteria in more or less the same manner (the conversion rate approximately doubles for each 10° C. by which the temperature is raised). However, in the case of a conventional de-ammonification in a single-tank system at low temperatures, the tank volume needed would be so great that this would no longer be economically feasible. The retention of the AMOX (which is also known internationally as ANAMMOX) by means of the method according to the invention allows an efficient process, even at low temperatures.

Due to the return of the heavy phase and due to the accumulation associated with this, the proportions of anaerobic ammonium-oxidizing bacteria (AMOX) relative to the nitrate-forming bacteria (NOB) are also shifted towards the anaerobic ammonium-oxidizing bacteria (AMOX). Consequently, the process of the nitrification/de-nitrification is shifted further towards de-ammonification. As a result, the aerated phase can also be operated at higher oxygen concentrations (>0.4 mg O₂/l) and the efficiency of the nitrite formation by the aerobic ammonium-oxidizing bacteria (AOB) can be more than doubled.

Moreover, the start-up time of a new system for treating wastewater can be considerably reduced since the proportion of anaerobic ammonium-oxidizing bacteria (AMOX) needed for a reliable de-ammonification can be achieved considerably more quickly through the introduction of a heavy phase stemming from another system.

A particularly advantageous refinement of the present method is also created in that the separation of the surplus sludge into a heavy phase and a light phase is carried out in a hydrocyclone. Thanks to the hydrocyclone, which is also referred to as a centrifugal separator, the surplus sludge can be converted very quickly and reliably into a heavy phase that is returned to the tank via an underflow of the hydrocyclone, and into a light phase that is discharged from the system via the overflow.

In an alternative modification of the method according to the invention, it is provided that the surplus sludge is separated into a heavy phase and a light phase in a centrifuge. A centrifuge makes use of inertia to separate the surplus sludge. Due to its inertia, the heavy sludge fraction having the higher density moves towards the outside and displaces the lighter sludge fraction having the lower density towards the center of the centrifuge.

It is also possible to employ sedimentation to separate the surplus sludge into a heavy phase and a light phase. Here, the surplus sludge is separated into a heavy phase and a light phase under the effect of gravity.

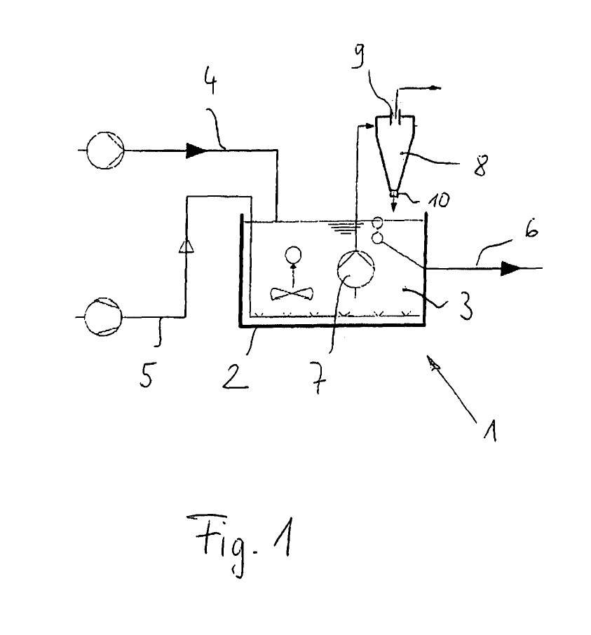

FIG. 1 shows a single-tank system 1 for treating wastewater 3 containing ammonium. The single-tank system 1 has a tank 2 to hold the wastewater 3 containing ammonium, a feed 4, an aerator 5 and a discharge 6. The ammonium contained in the wastewater 3 is first converted into nitrite by means of aerobic oxidizing bacteria (AOB). Subsequently, by means of anaerobic ammonium-oxidizing bacteria (AMOX), especially Planctomycetes, the ammonium and the previously converted nitrite are converted into elementary nitrogen. The surplus sludge generated by the reactions is fed into a hydrocyclone 8 by a pump 7. In the hydrocyclone 8, the surplus sludge is separated into a heavy phase that contains primarily the anaerobic ammonium-oxidizing bacteria (AMOX), and into a light phase. The light phase is discharged via the overflow 9 of the hydrocyclone 8 and then disposed of, while the heavy phase is returned to the tank 2 of the single-tank system 1 via the underflow 10 of the hydrocyclone 8.

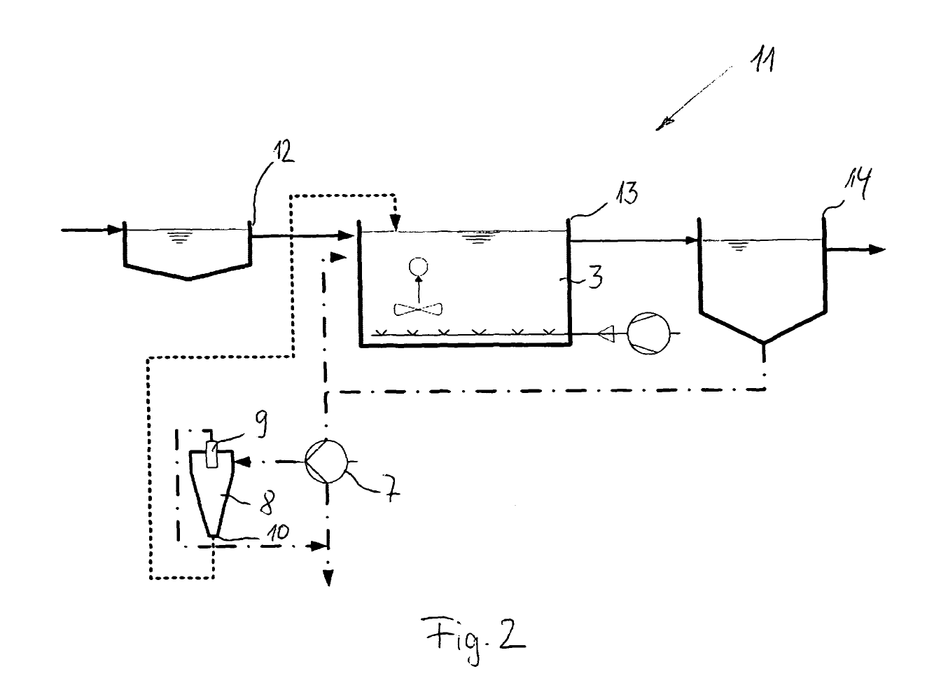

FIG. 2 shows an activated-sludge system 11 for treating wastewater 3 containing ammonium. The wastewater 3 goes from a primary clarification tank 12 via an aeration tank 13—where the wastewater 3 is aerated—into a secondary clarification tank 14. In this secondary clarification tank 14, the activated sludge is separated from the wastewater 3 by means of sedimentation and partially returned to the aeration tank 13 as return sludge or else disposed of as surplus sludge. A pump 7 feeds the surplus sludge into a hydrocyclone 8. In the hydrocyclone 8, the surplus sludge is separated into a heavy phase that contains primarily the anaerobic ammonium-oxidizing bacteria (AMOX), and into a light phase. The light phase is discharged via the overflow 9 of the hydrocyclone 8 and then disposed of appropriately, while the heavy phase is returned to the aeration tank 13 via the underflow of the hydrocyclone 8.

While the invention has been particularly shown and described with reference to preferred embodiments thereof, it will be understood by those skilled in the art that various changes in form and details may be made therein without departing from the spirit and scope of the invention.

1-4. (canceled)

5. A method for treating wastewater containing ammonium in a de-ammonifying activated-sludge system, the method comprising:
converting a portion of the ammonium into nitrite using aerobically oxidizing bacteria;
converting another portion of the ammonium and the nitrite into elementary nitrogen using anaerobically oxidizing bacteria so as to generate a surplus sludge;
removing the surplus sludge from the waste water; and
separating the surplus sludge into a heavy phase including primarily anaerobic ammonium-oxidizing bacteria and a light phase, wherein the heavy phase is at least one of collected and returned to the system.

6. The method recited in claim 5, wherein the anaerobically oxidizing bacteria includes Planctomycetes.

7. The method as recited in claim 5, wherein the separating the surplus sludge into the heavy phase and the light phase is performed using a hydrocyclone.

8. The method as recited in claim 5, wherein the separating the surplus sludge into the heavy phase and the light phase is performed using a centrifuge

9. The method as recited in claim 5, wherein the separating the surplus sludge into the heavy phase and the light phase occurs by sedimentation.

10. The method as recited in claim 6, wherein the separating the surplus sludge into the heavy phase and the light phase is performed using a hydrocyclone.

11. The method as recited in claim 6, wherein the separating the surplus sludge into the heavy phase and the light phase is performed using a centrifuge

12. The method as recited in claim 6, wherein the separating the surplus sludge into the heavy phase and the light phase occurs by sedimentation.
